(19) United States
(12) Patent Application Publication
(10) Pub. No.: US 2004/0040199 A1
(43) Pub. Date: Mar. 4, 2004

(54) System for protecting trees and structures against infestation

(76) Inventors: James Thompson, London Ontario (CA); Timothy G. Myles, Georgetown Ontario (CA)

Correspondence Address: ANISSIMOFF & ASSOCIATES, RICHMOND NORTH OFFICE CENTRE, SUITE 201, 235 NORTH CENTRE RD., LONDON, ON, N5X 4E7, CA

(21) Appl. No.: 10/399,624

(22) PCT Filed: Oct. 18, 2001
(86) PCT No.: PCT/CA01/01460

(51) Int. Cl. A01G 13/02; A01M 1/18

(52) U.S. Cl. 43/108; 47/32.5

(57) ABSTRACT

A system for protecting trees and structures from infestation by crawling or climbing insects by attaching an insect barrier to the wall surface of the object to be protected. The barrier consists of a belt means, which may be made from a plastic sheet material and may be wrapped around the object to be protected, including a contact means that engages the surface of the object. The contact means may have a deformable thickness, such as provided by a layer of a non-woven fabric, to prent the passage of insects between the barrier and the surface of the objet. The free ends of the belt means are secured to each other to retain the belt means against the surface of the tree and engage the contact means against the tree surface. The belt means has slippery surface means, having a low coefficient of friction with respect to insects, that prevents the travel of insects on the belt means, preventing them from proceeding over the belt means and infesting the tree or structure to be protected. The slippery surface means may be provided by application of a coating of a fluoro-polymer, such as poly-tetra-fluoro ethylene (PTFE), to the belt means or may be otherwise suitably attached to or integrally formed with the belt means.

### BACKGROUND OF THE INVENTION

1. Field of the Invention

The invention is directed to a system for protecting trees and some structures against infestation from climbing insects, and to a banding product to reduce the accessibility of trees and structures to such insects, including the geometrid species in regard to trees.

2. Description of the Prior Art

Infestation by insects is commonplace, frequently involving upward invasion from the ground. The damage resulting from some such infestations can be widespread, both in variety and extent. For many years, trees throughout North American have suffered infestation from climbing insects, as exemplified by a class of geometrid insects. There are approximately sixteen species of this particular insect in North America and nineteen species active elsewhere in the world. Ion the case of the geometrids, the female is flightless, and on a seasonal basis, she climbs up the trunk of a tree to lay her eggs in the upper parts of the tree. The eggs hatch into larvae, which feed on the foliage of the host tree, causing serious damage to the foliage, with consequent damage to the health of the tree, thereby increasing its vulnerability to diseases, such a Dutch elm disease.

Also, the productivity off the tree is diminished, in terms both of fruit and wood yield. The damage to the foliage of the trees also exacts an aesthetic penalty in diminished attractiveness, and with a loss of shade, that affects both individuals and the general public. Efforts to deal with this problem have extended over decades, the best known being the application of a sticky barrier layer of “Tanglefoot™” around the trunk of the tree, to impede or prevent the passage of the crawling insect up the trunk. This unsightly, sticky oily substance is labour intensive in its application, and requires to be maintained on a weekly basis, to remain effective. It has been known to adversely affect the health of the subject tree, even to the extent of possible mortality.

Further features of the invention will be described or will become apparent in the course of the following detailed description.

### SUMMARY OF THE INVENTION

The present invention provides a system for protecting trees and other generally vertical surfaces against climbing insects, including geometrids.

The system comprises the steps of applying a no-pass belt across a surface normally traversed by the climbing insect, over which belt an insect must pass, and where necessary, applying a complementary localized blocking barrier adjoining the no-pass belt, to deny alternative passage for the crawling insect under or past the barrier. This combination of elements forms an insect barrier that may be applied to a structure to be protected from insect infestation, such as a tree.

Thus, in the case of geometrid and other crawling insects, the insect is denied access to attaining its natural, egg-laying or feeding habitat, thereby disrupting its breeding and/or feeding cycle. The natural cycles of other climbing or descending insects can also be interrupted, with beneficial results to the “host”.

One aspect of a no-pass barrier can be the provision of a slippery surface coating that can cause an insect to slip off the no-pass belt and fall from the tree, and as it cannot re-ascend over the belt, for feeding purposes, the life cycle is effectively interrupted.

In the case of climbing insects, in addition to applying a no-pass belt about the trunk or limb of a tree, or across an upright structural surface, a complementary adjoining barrier which conforms substantially to irregularities, convolutions and crevices of the tree or structure surface may be applied, to substantially bar upward passage of insects, including the geometrid female up such irregularities, thereby causing the insect to attempt passage over the adjoining surface of the no-pass belt, which is preferably raised by the barrier, to promote a clear fall from the no-pass belt.

The no-pass belt can have a band of low friction or otherwise slippery material across which the insect cannot proceed, so that the insect tends to fall to the ground. A so-called no-stick material such as Teflon™ or other PTFE-based or resin-bonded material may be applied as a lubricant to the surface, having an extremely low coefficient of friction. In the case of a geometrid, being unable to maintain itself upon the tree, it is thereby disrupted in its habitual egg-laying procedure, while the fall from the tree renders it extremely vulnerable to consumption by birds and the like.

The no-stick embodiment of the no-pass belt may include a protuberant section profile, over which the insect must climb, in order to proceed in its upward passage. The profile of the protuberant section, and thereby the path to be traveled by the insect, may be either outwardly extending to a substantially horizontal portion or downwardly extending to a substantially vertical portion to form a surface that must be traversed by the insect. Passage of the insect onto the protuberant profile causes it to re-orient itself into an inverted posture, so that its grip on the no-stick surface of the no-pass belt is further diminished, and the insect more readily falls from the belt. A range of materials may be used for the blocking barrier, and may include an adhesive surface. In field tests, a Fiberglas™ thermal insulation tape, comprising a paper backing band with fiberglass insulation adhered to one side was used successfully as the blocking barrier, having a single wrap secured about each tree, with the paper side outermost, compressing the fibers. Though fiberglass is but one embodiment of a non-woven fabric, other non-woven fabric materials made of different materials, such as plastic, could be used to produce similar effects.

A no-pass belt of rubber-like material having a bulged profile of substantially triangular section and a smooth outer surface, extending about the blocking barrier, functioned effectively to “discard” the egg-bearing geometrid insects, so that a very low percentage of the insects managed to attain their destination in the tree, and lay their eggs.

An improved blocking barrier may consist of foamed plastic, being soft enough to adequately enter and effectively block-off the irregularities of the bark. This barrier may be used in combination with a low-friction plastic or paper no-pass belt, to the back of which the foam may be adhered.

As an alternative to a pre-fabricated barrier/belt, a foam plastic may be applied at site, as one or more continuous beads to the back of the no-pass belt. The plastic bead or beads then foam and expand, so that by firmly wrapping the no-pass belt about a tree trunk, with the freshly deposited plastic against the bark, such expansion causes penetration of the plastic foam into the irregularities of the bark, effectively blocking them off, to substantially preclude the passage of insects such as the female geometrid therethrough.

A low-friction outer surface of the no-pass belt may then suffice to cause any crawling insects to fall off the tree trunk.

Alternatively to the on-site application of foamed plastic to a backing paper, a liquid foaming plastic may be applied directly to the surface of the tree, to completely fill and block the discontinuities, and form with the surrounding band a type of sandwich, over which the no-pass band may be secured. In such instance, a peripheral marker line may be used, to facilitate the application. In the case of previously prepared blocking barriers, it will be understood that additional foam or other blocking material may be applied on-site to supplement the pre-formed pliant barrier material, so as to complete an effective barrier sandwich.

The condition and amount of the bead of the barrier plastic applied to the rear face of a no-pass belt may be such as to provide the barrier belt with a significant outward bulge, to enhance the likelihood that the belt will “discard” any crawling insects such as the egg-distended geometrids.

A further embodiment that may utilize a variety of blocking media secured to the back surface of the no-pass belt has an extruded belt with at least one projecting rib, providing an outwardly extending barrier of sufficient extent that the insect cannot attain the edge of the rib, and as it moves out onto the rib, the insect imperatively adopts an inverted and unsupported posture, so that a fall from that surface is virtually inevitable. More than one such rib may be employed.

A further combination, for use against more sure-footed insects, incorporates with the no-pass belt, upon a portion of its outer, smooth surface, a peripheral band of sticky substance, akin to or consisting of the above-mentioned Tanglefoot™. This enables utilization of otherwise noxious substances in isolated relation from the tree or other plant organism that is being protected.

In addition to use with trees and plants, the present invention also lends itself to use with structures, to limit the access to the structure of a variety of climbing creatures, particularly insects.

The subject barrier band also lends itself to use with noxious matter containing substances such as insecticides that are normally used only within a protected environment.

By installing a barrier band having an overhanging protuberance that serves both as a compound retainer and as a weather shed, such noxious substance can be applied within the protection of the weather shed, where it is protected from the elements and from being washed off by rain, while retaining its location and potency against the targeted insect or group of insects.

According to a main aspect of the invention, an insect barrier is provided for attachment to a wall surface of an object for preventing the travel of insects over the barrier from a position below the barrier to a position above the barrier, said barrier comprising belt means having a length and a width and including contact means for engagement with said wall surface to prevent the passage of insects therebetween, said belt means further having a slippery surface to prevent the travel of insects thereon. The wall surface is substantially vertical. The slippery surface has a low coefficient of friction with respect to insects, thereby disabling the insects from travelling thereon against gravity. The belt means comprises a plastic sheet material and the slippery surface may include a coating of a fluoro-polymer applied to the sheet. The fluoro-polymer may in turn include poly-tetra-fluoro ethylene (PTFE). The contact means may be a layer of non-woven fabric material between the belt means and the wall surface, having a deformable thickness to engage the wall surface to prevent the passage of insects therebetween, which may be adhesively attached to the belt means. The non-woven fabric material may alternatively be made of a plastic material. The width of the belt means may extend below the layer of non-woven fabric material to form a downwardly extending portion of the belt means, and the slippery surface may be applied to both the inside and outside of the downwardly extending portion.

The belt means is circumferentially wrapped around the tree and the attachment consists of securing the free ends of the length of the belt means to each other to retain the belt means against the tree surface and engage the contact means against the tree surface. The belt means may be retained against the tree surface and the contact means engaged against the tree surface by strapping means circumferentially wrapped about the belt means and in pressing relation therewith. The belt means may be alternatively retained by stapling means or adhesive means.

A method is provided for protecting a tree from insects by means of attaching the insect barrier as previously described to a tree by means of circumferentially wrapping the belt means around the tree and securing the free ends of the belt means to each other, thereby retaining the belt means against the tree surface and engaging the contact means against the tree surface and attaching by suitable means.

### BRIEF DESCRIPTION OF THE DRAWINGS

Certain embodiments of the invention are described by way of illustration, without limitation thereto other than as set forth in the accompanying claims, reference being made to the accompanying drawings, wherein:

FIG. 1 is a perspective view of the insect barrier according to the present invention attached circumferentially about a tree.

FIG. 2 is a cross sectional view of an embodiment of the insect barrier, shown in FIG. 1.

FIG. 3 is a cross sectional view of another embodiment of the insect barrier.

FIG. 4 is a yet another embodiment of the insect barrier.

FIG. 5 is a cross sectional view of yet another embodiment.

FIG. 6 is a cross section of yet another embodiment wherein the surface of the belt means is convexly curved.

### PREFERRED EMBODIMENT

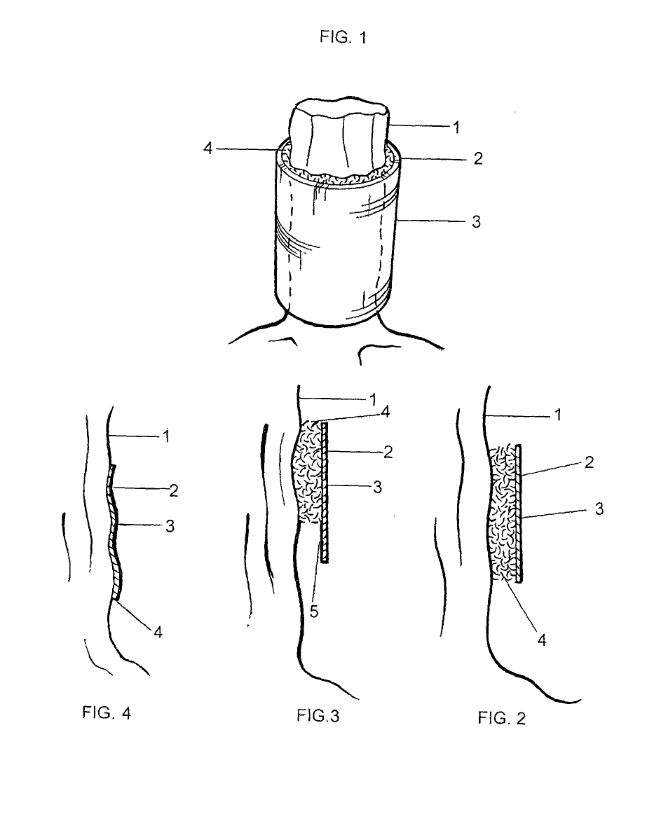

FIG. 1 shows a perspective view of the insect barrier of the present invention as attached about a tree (1). The insect barrier has belt means (2), having a length and width, wherein the length of said belt means is circumferentially wrapped around the tree. The belt means has a slippery surface (3) with a low coefficient of friction with respect to insects, thereby disabling said insects from travelling thereon against gravity. The belt means may be formed of a flexible plastic sheet material, and the slippery surface may be provided by application of a coating to the belt means containing a fluoropolymer, such as PTFE. The belt means includes a contact means (4) comprising a layer of a material with a deformable thickness, such as a non-woven fabric, for engagement with the surface of the tree, thereby preventing the passage of insects between the barrier and the tree surface. The non-woven fabric material may be made of a plastic material or a fiberglass material. The contact means may be adhered to the inside surface of the belt means.

The attachment of the belt means to the tree consists of securing the free ends (not shown) of the length of said belt means to each other to thereby retain said belt means against said tree surface and engage said contact means against said tree surface. This may be accomplished by circumferentially wrapping strapping means about the belt means (not shown) or by stapling or adhesive attachment (not shown).

Referring to FIG. 2, a cross section of one embodiment of an insect barrier is shown. The belt means (2) is substantially vertical and includes a contact means (4) which engages the tree (1) surface to prevent the passage of insects between the insect barrier and the tree, forcing said insects to traverse the surface of the belt means, which causes them to fall off of the barrier due to the slippery surface of said belt means (3). The barrier is placed in a raised position with respect to the ground, but the barrier may be attached to any portion of the tree or structure below the portion desired to be protected from infestation by said insects.

FIG. 3 shows a cross sectional view of another embodiment of the invention, also having a substantially vertical surface, belt means (2), and contact means (4). In this embodiment, the width of the belt means is greater than the width of the contact means, forming a downwardly extending portion of the belt means (5) which has a slippery surface (3) on both sides. Insects are still blocked from upward travel by the contact means, which is in engagement with the tree (1) surface as in the previous embodiments. The insect is thereby forced to downwardly traverse the downwardly extending portion of the belt means. Sure footed insects that are not downwardly removed from the inside slippery surface of the downwardly extending portion by means of gravity are forced to adopt an inverted posture while attempting to traverse the lowermost edge of the belt means. This puts the insect in a precarious position, increasing the likelihood of said insect loosing its grip on the surface and falling therefrom, thereby increasing the efficacy of the insect barrier in preventing the passage of said insect.

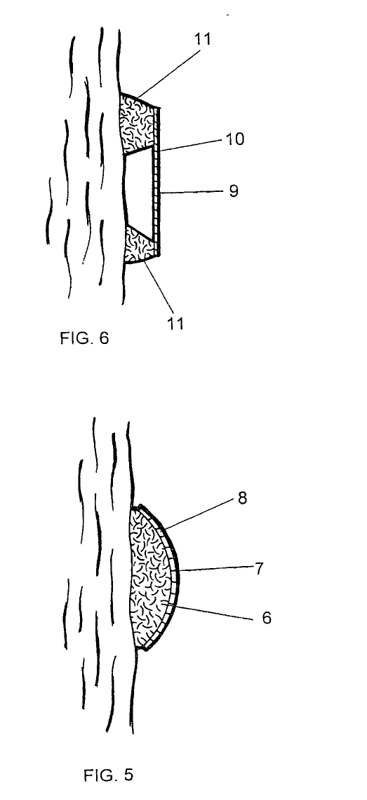

FIG. 4 shows another embodiment of an insect barrier, wherein the belt means (2), having a slippery surface (3), substantially conforms to the surface profile of the tree (1). Without the need for any separate contact means, a contact means (4) is, however, provided on the reverse side of the belt means to engage the surface of the tree, thereby preventing the passage of insects between the insect barrier and the tree. The contact means may be adhesively applied to the tree, and the belt means may be adhesively applied to the contact means. The contact means may be a foamed plastic material and may have a layer of a non-woven fabric material included therewith.

The FIG. 5 barrier embodiment comprises an outwardly arcuate foam body portion (6), having an outer segment (7) of no-stick, low friction plastic. The belt embodiment (8) can be cut to length so that the ends are in mutual, snuggly abutting relation, for securing by adhesive tape or staple. Turning to the FIG. 6 belt embodiment, a vertical planar tape (9) having a no-stick outer surface (10) has a pair of sealing strips (11) of soft plastic on the reverse (inner) face. Fastening of the belt may include stapling to itself or to the tree, taping, or even gluing. The tree-side foamed plastic may carry a contact adhesive, protected by a peelable slip-coated paper protection. In instances where supplemental, in-situ foaming may be applied, the two sealing strips (11) may serve as walls of a reservoir, to receive and contain the supplemental foam application.

A number of variations in the formulation and production of the tree insect barriers may be adopted, while lying within the ambit of the claims of the present invention.

While being disclosed with particular regard to use with trees and vertical structural components, and for particular use against one class of climbing insects, it will be evident that the present invention may be used in a variety of guises and situations, and in combination with a range of insecticides, and for a wide range of creatures.

1. An insect barrier for attachment to a wall surface of an object for preventing the travel of insects past the barrier from a position below the barrier to a position above the barrier, the barrier comprising belt means and contact means, the contact means comprising a layer of non-woven fabric material having a deformable thickness for engagement with the wall surface to prevent the passage of insects, the belt means comprising a surface to prevent the travel of insects thereon.

2. The insect barrier as claimed in claim 1, wherein the layer of non-woven fabric material is adhesively attached to the belt means.

3. The insect barrier as claimed in claim 1 or 2, wherein the non-woven fabric material is made of a plastic material.

4. The insect barrier as claimed in any one of claim 1 to 3, wherein the belt means further comprises a downwardly extending portion that extends below the contact means.

5. An insect barrier for attachment to a wall surface of an object for preventing the travel of insects past the barrier from a position below the barrier to a position above the barrier, the barrier comprising belt means and contact means for engagement with the wall surface to prevent the passage of insects, the belt means comprising a surface to prevent the travel of insects thereon and a downwardly extending portion that extends below the contact means.

6. The insect barrier of claim 4 or 5, wherein the surface to prevent the travel of insects thereon is on the downwardly extending portion of the belt means.

7. The insect barrier of claim 6, Wherein the surface to prevent the travel of insects thereon is on the inside of the downwardly extending portion.

8. The insect barrier of any one of claims 1 to 7, wherein the surface to prevent the travel of insects thereon comprises a sticky substance, an insecticide, or a combination thereof.

9. The insect barrier of any one of claim 1 to 7, wherein the surface to prevent the travel of insects thereon comprises a slippery surface.

10. The insect barrier as claimed in claim 9, wherein the slippery surface has a low coefficient of friction with respect to insects, thereby disabling the insects from travelling thereon against gravity.

11. The insect barrier as claimed in claim 9 or 10, wherein the belt means comprises a plastic sheet material and the slippery surface includes a coating of a fluoropolymer applied to the sheet.

12. The insect barrier as claimed in claim 11, wherein the fluoro-polymer includes poly-tetra-fluoro ethylene (PTFE).

13. The insect barrier as claimed in any one of claims 1 to 12, wherein the wall surface is a surface of a man-made structure.

14. The insect barrier as claimed in any one of claims 1 to 12, wherein the wall surface is a surface of a plant.

15. The insect barrier as claimed in claim 14, wherein the wall surface is a surface of a tree.

16. The insect barrier as claimed in any one of claims 1 to 15, wherein the wall surface is substantially vertical.

17. A method for protecting a tree from insects by attaching the insect barrier of claim 15 to the tree, the method comprising:
a) circumferentially wrapping the barrier around the tree;
b) engaging the contact means with the tree; and,
c) securing the free ends of the belt means to each other.

18. The method of claim 17 wherein the free ends of the belts means are secured in abutting relation.

19. The method of claim 17 or 18, wherein the free ends of the belt means are adhesively secured.

20. The method of claim 19, wherein the free ends of the belt means are secured using an adhesive tape.

21. The method of any one of claims 17 to 20, wherein a strapping means is circumferentially wrapped about the belt means.

22. The method of any one of claims 17 to 21, wherein the belt means is attached by stapling.

23. An insect barrier for attachment to a plant for preventing the travel of insects past the barrier from a position below the barrier to a position above the barrier, the barrier comprising belt means and contact means, the contact means comprising a layer of non-woven fabric material having a deformable thickness for engagement with the wall surface to prevent the passage of insects, the belt means comprising a downwardly extending portion that extends below the contact means and a surface to prevent the travel of insects thereon on the downwardly extending portion.
